(19) United States
(12) Patent Application Publication
(10) Pub. No.: US 2023/0206600 A1
(43) Pub. Date: Jun. 29, 2023

(54) INFORMATION PROCESSING SYSTEM, INFORMATION PROCESSING DEVICE, NON-TRANSITORY COMPUTER-READABLE MEDIUM, AND INFORMATION PROCESSING METHOD

(71) Applicant: Mitsubishi Electric Corporation, Tokyo (JP)

(72) Inventor: Ryota SEKIGUCHI, Tokyo (JP)

(73) Assignee: Mitsubishi Electric Corporation, Tokyo (JP)

(21) Appl. No.: 18/118,417

(22) Filed: Mar. 7, 2023

Related U.S. Application Data
(63) Continuation of application No. PCT/JP2020/035982, filed on Sep. 24, 2020.

(51) Int. Cl. G06V 10/74; G06T 7/20; G06T 7/62; G06V 10/25

(52) U.S. Cl. CPC G06V 10/761; G06T 7/20; G06T 7/62; G06V 10/25; G06T 2207/10028; G06T 2207/30241; G06V 2201/07

(57) ABSTRACT

An information processing system (100) includes a rangefinding and processing unit (101) that generates rangefinding information indicating the distance and direction to each of a plurality of rangefinding targets; an imaging and processing unit (104) that generates image data of a captured image, specifies the distance, direction, and type of an imaged target, and generates imaging information indicating the distance, direction, and type of the imaged target; and a control unit (114) that specifies tentative values indicating the sizes of the rangefinding targets by using the imaging information, specifies a plurality of tentative areas, which are areas where the rangefinding target are projected, in accordance with the tentative values and the rangefinding information, and calculates match probability indicating the possibility of the imaged target matching each of the rangefinding targets by using the dimension of an overlap between each of the tentative areas and a target area.

### CROSS-REFERENCE TO RELATED APPLICATION

This application is a continuation application of International Application No. PCT/JP2020/035982 having an international filing date of Sep. 24, 2020.

### BACKGROUND OF THE INVENTION

### 1. Field of the Invention

The disclosure relates to an information processing system, an information processing device, a non-transitory computer-readable medium, and an information processing method.

### 2. Description of the Related Art

In vehicle control systems, such as driver-assistance systems or autonomous driving systems, detection accuracy of sensors is improved by using multiple sensors for supplementing or redundancy.

For example, Patent Literature 1 discloses an object-detecting device that performs sensor fusion by using a radar sensor device and a camera sensor device.

A conventional object-detecting device determines that a target detected by the camera sensor device and a target detected by the radar sensor device are identical when thetarget detected by the radar sensor device is included within a threshold range corresponding to the width of the target detected by the camera sensor device.

Patent Literature 1: Japanese Patent Application Publication No. 2014-6123

### SUMMARY OF THE INVENTION

However, if a target detected by the radar sensor device is included within the threshold range corresponding to the width of the target detected by the camera sensor device, the conventional object-detecting device determines that every target at any distance is identical, and this may lead to a determination error of determining different targets as a same target.

Accordingly, an object of at least one aspect of the disclosure is to reduce determination errors in determining the identity of a target.

An information processing system according to an aspect of the disclosure includes: a sensor to detect distance to each of a plurality rangefinding targets, the rangefinding targets being targets present in a detection range; an imaging device to capture an image with at least a portion of an imaging range overlapping the detection range and generate image data indicating the image; and processing circuitry to generate rangefinding information indicating the distance and direction to each of the rangefinding targets based on a result of detection by the sensor; to specify distance, direction, and type of an imaged target, and generate imaging information indicating the distance, direction, and type of the imaged target, the imaged target being a target included in the image; and to specify tentative values indicating sizes of the rangefinding targets by using the imaging information, specify a plurality of tentative areas in accordance with the tentative values and the rangefinding information, and calculate match probability indicating possibility of the imaged target matching each of the rangefinding targets by using a dimension of an overlap between each of the tentative areas and a target area, the tentative areas being areas where the rangefinding targets are projected onto the image, the target area being an area in the image capturing the imaged target.

According to at least one aspect of the disclosure, determination errors in determining the identity of a target can be reduced.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram schematically illustrating a configuration of a vehicle control system according to first to fifth embodiments;

FIG. 2 is a schematic diagram illustrating a tentative value table as an example of tentative value information;

FIG. 3 is a block diagram schematically illustrating a configuration of a control unit according to the first to third embodiments;

FIG. 4 is a schematic diagram for explaining targets indicated by rangefinding information and targets indicated by imaging information in the first embodiment;

FIG. 5 is a schematic diagram illustrating an image obtained by projecting rangefinding targets onto an image captured by an imaging unit in the first embodiment;

FIG. 6 is a schematic diagram illustrating an image obtained by projecting tentative areas corresponding to rangefinding targets onto an image captured by the imaging unit in the first embodiment;

FIG. 7 is a block diagram illustrating a hardware configuration example of a vehicle control system;

FIG. 8 is a flowchart illustrating a process executed in an information processing device according to the first embodiment;

FIG. 9 is a schematic diagram for explaining targets indicated by rangefinding information and targets indicated by imaging information in the third embodiment;

FIG. 10 is a schematic diagram illustrating an image obtained by projecting rangefinding targets onto an image captured by an imaging unit in the third embodiment;

FIG. 11 is a block diagram schematically illustrating a configuration of a control unit according to the fourth embodiment;

FIG. 12 is a flowchart illustrating a process executed in an information processing device according to the fourth embodiment;

FIG. 13 is a block diagram schematically illustrating a configuration of a control unit according to the fifth embodiment;

FIG. 14 is a schematic diagram for explaining targets indicated by rangefinding information and targets indicated by imaging information in the fifth embodiment;

FIG. 15 is a schematic diagram illustrating an image obtained by projecting tentative areas corresponding to rangefinding targets onto an image captured by the imaging unit in the fifth embodiment;

FIG. 16 is a top-view diagram of a range of an image captured by an imaging unit, rangefinding targets, and imaged targets in a first modification of the first to fifth embodiments;

FIG. 17 is a schematic diagram illustrating tentative areas of rangefinding targets in the first modification;

FIG. 18 is a top-view diagram of a range of an image captured by an imaging unit, rangefinding targets, and imaged targets in a second modification of the first to fifth embodiments; and

FIG. 19 is a schematic diagram illustrating an image obtained by projecting tentative areas corresponding to rangefinding targets onto an image captured by the imaging unit in the second modification.

### DETAILED DESCRIPTION OF THE INVENTION

### First Embodiment

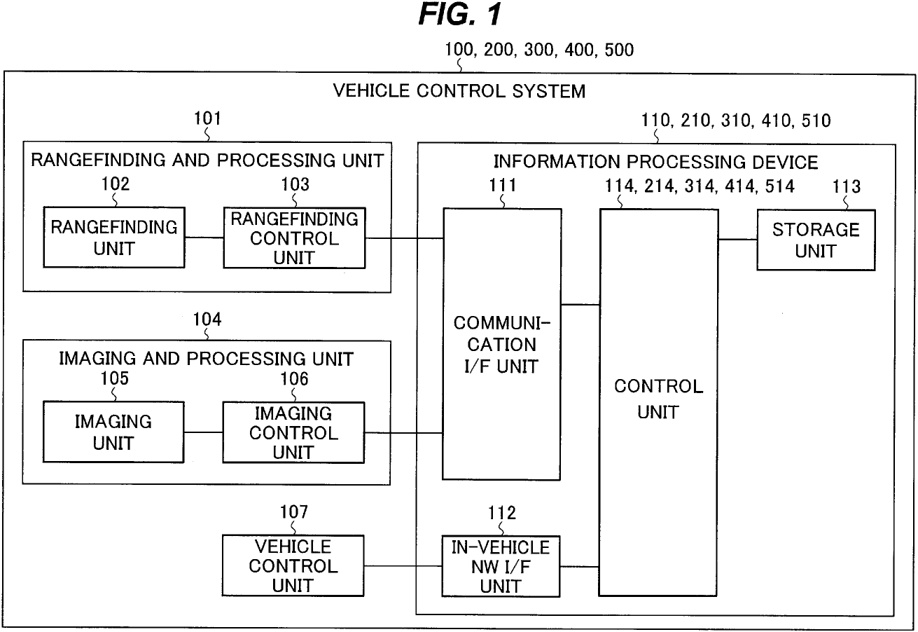

FIG. 1 is a block diagram schematically illustrating a configuration of a vehicle control system 100 serving as an information processing system according to the first embodiment.

The vehicle control system 100 includes a rangefinding and processing unit 101, an imaging and processing unit 104, a vehicle control unit 107, and an information processing device 110.

The vehicle control system 100 is mounted on a vehicle (not illustrated). The vehicle is an automobile, a train, or the like.

The rangefinding and processing unit 101 detects the distance and direction to each of a plurality of rangefinding targets, which are targets present in a detection range, and generates rangefinding information indicating the distance and direction to each rangefinding target. The generated rangefinding information is given to the information processing device 110.

The rangefinding and processing unit 101 includes a rangefinding unit 102 and a rangefinding control unit 103.

The rangefinding unit 102 measures the distance to a target. The rangefinding unit 102 gives the measured result to the rangefinding control unit 103. For example, the rangefinding unit 102 may measure the distance to the target by a known method using millimeter-waves, pulsed laser, or the like.

The rangefinding control unit 103 generates rangefinding information indicating the distance and direction to the detected target from the detection result obtained by the range finding unit 102. The rangefinding control unit 103 then gives the generated rangefinding information to the information processing device 110.

The imaging and processing unit 104 captures an image with at least a portion of an imaging range overlapping a detection range of the rangefinding and processing unit 101, and generates image data indicating the image. The imaging and processing unit 104 then specifies the distance, direction, and type of the imaged target, which is the target included in the captured image, and generates imaging information indicating the distance, direction, and type of the imaged target. The generated imaging information is given to the information processing device 110.

The imaging and processing unit 104 includes an imaging unit 105 and an imaging control unit 106.

The imaging unit 105 captures an image of a target. The imaging unit 105 gives the image data of the captured image to the imaging control unit 106.

The imaging control unit 106 specifies the target included in the image indicated by the image data provided by the imaging unit 105, and specifies the distance, direction, and type of the target. When the image includes multiple targets, the imaging control unit 106 specifies the distance, direction, and type of each target. The imaging control unit 106 may specify the distance, direction, and type of the target by a known method using disparity, pattern matching, or the like. The imaging control unit 106 then gives the imaging information indicating the specified distance, direction, and type of each target and the image data to the information processing device 110.

The vehicle control unit 107 generates vehicle information, which is information related to running of a vehicle on which the vehicle control system 100 is mounted, and gives the vehicle information to the information processing device 110.

The vehicle information indicates the vehicle’s steering angle, speed, yaw rate, or the like. Since the information processing device 110 according to the first embodiment does not use the vehicle information, the vehicle control unit 107 may not be provided.

The information processing device 110 performs a process of specifying the distance and direction to a target that is to be detected by the vehicle control system 100.

The information processing device 110 includes a communication interface unit (communication I/F unit) 111, an in-vehicle network interface unit (in-vehicle NW I/F unit; 112, a storage unit 113, and a control unit 114.

The communication I/F unit 111 communicates with the rangefinding and processing unit 101 and the imaging and processing unit 104. For example, the communication I/F unit 111 acquires rangefinding information from the rangefinding and processing unit 101 and gives the rangefinding information to the control unit 114. The communication I/F unit 111 also acquires imaging information and image data from the imaging and processing unit 104 and gives the imaging information and the image data to the control unit 114.

The in-vehicle NW I/F unit 112 communicates with the vehicle control unit 107. For example, the in-vehicle NW I/F unit 112 acquires vehicle information from the vehicle control unit 107 and gives the vehicle information to the control unit 114.

The storage unit 113 stores information and programs necessary for processing executed in the information processing device 110. For example, the storage unit 113 stores tentative value information that associates the target types with tentative values indicating target sizes.

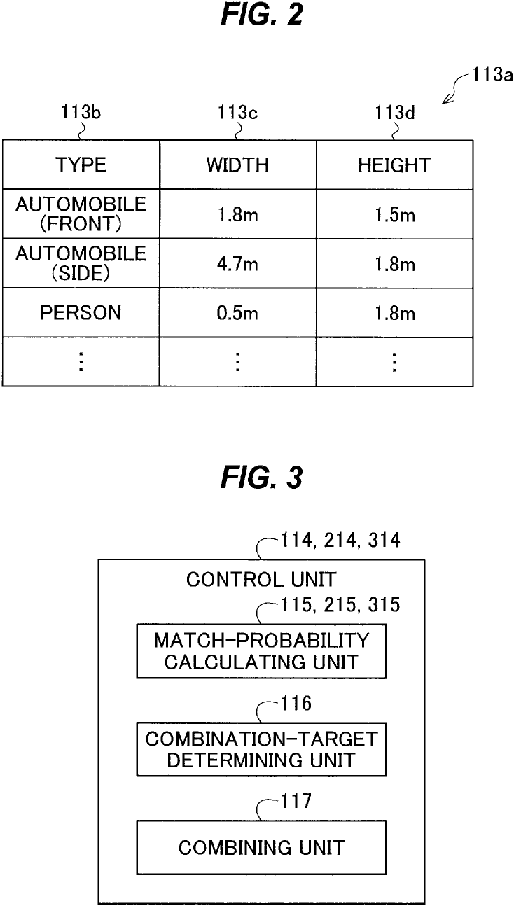

FIG. 2 is a schematic diagram illustrating a tentative value table 113a as an example of tentative value information.

The tentative value table 113a is table information having a type column 113b, a width column 113c, and a height column 113d.

The type column 113b stores target type.

The width column 113c stores target width.

The height column 113d stores target height.

The tentative value table 113a allows the size of a target to be specified on the basis of the target width and the target height, which are tentative values.

Referring back to FIG. 1, the control unit 114 controls the processing executed in the information processing device 110. For example, the control unit 114 determines whether or not the target indicated by the rangefinding information provided by the rangefinding and processing unit 101 is identical to the target indicated by the imaging information provided by the imaging and processing unit 104, and when the targets are identical, the distance and direction indicated by the rangefinding information are combined with the distance and direction indicated by the imaging information.

FIG. 3 is a block diagram schematically illustrating a configuration of the control unit 114 according to the first embodiment.

The control unit 114 includes a match-probability calculating unit 115, a combination-target determining unit 116, and a combining unit 117.

The match-probability calculating unit 115 uses the imaging information from the imaging and processing unit 104 to specify tentative values indicating the sizes of multiple rangefinding targets, and, in accordance with the tentative values and the rangefinding information from the rangefinding and processing unit 101, specifies multiple tentative areas that are areas where the rangefinding targets are projected onto the image indicated by image data. The match-probability calculating unit 115 then calculates the match probability indicating the possibility of the imaged target matching each of the rangefinding targets by using the dimension of the overlap between each of the tentative areas and the target area, which is the area, capturing the imaged target in the image.

For example, the match-probability calculating unit 115 calculates match probability that increases as the dimension of the overlap between each of the tentative areas and the target area increases. Specifically, the match-probability calculating unit 115 calculates match probability that increases as the area of the overlap between each of the tentative areas and the target area increases. The match-probability calculating unit 115 may alternatively calculate match probability that increases as the width of the overlap between each of the tentative areas and the target area increases.

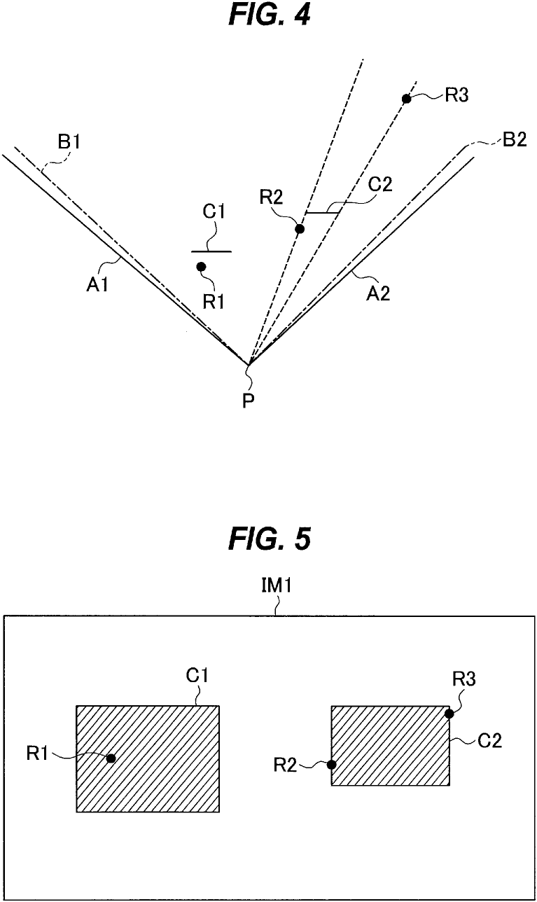

FIG. 4 is a schematic diagram for explaining targets indicated by rangefinding information and targets indicated by imaging information in the first embodiment.

FIG. 4 is a top-view diagram of a range of an image captured by the imaging unit 105, rangefinding targets, and imaged targets.

An image of an imaging range A1 to A2 having a certain angle of view relative to a lens position P, which is the position of the lens in the imaging unit 105, is captured.

The imaging range A1 to A2 includes imaged targets C1 and C2.

In the imaging range A1 to A2, rangefinding targets R1, R2, and R3 are detected.

In FIG. 4, a range B1 to B2 is a detection range of the rangefinding unit 102. In FIG. 4, the imaging range A1 to A2 includes the detection range B1 to B2, and at least some of these ranges should overlap each other.

FIG. 5 is a schematic diagram illustrating an image IM1 obtained by projecting rangefinding targets R1, R2, and R3 onto an image captured by the imaging unit 105 in the first embodiment.

The image captured by the imaging unit 105 captures imaged targets C1 and C2, and the rangefinding targets R1, R2 and R3 are projected onto the image in the directions indicated by the rangefinding information.

The areas of the imaged targets C1 and C2 illustrated in FIG. 5 are each a target area.

Under the circumstances described above, the match-probability calculating unit 115 calculates the match probability for each imaged target to specify a matching rangefinding target.

In the following, an imaged target that specifies a matching rangefinding target is also referred to as a target imaged target.

Specifically, the match-probability calculating unit 115 specifies the type of the target imaged target from the imaging information and specifies the size corresponding to the specified type from the tentative value table 113a.

On the basis of the specified size, the match-probability calculating unit 115 projects a tentative area corresponding to the rangefinding target onto the image captured by the imaging unit 105 in a size corresponding to the distance of the rangefinding target.

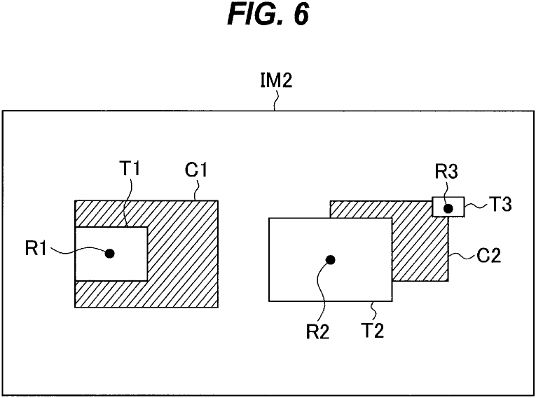

FIG. 6 is a schematic diagram illustrating an image IM2 obtained by projecting a rangefinding a tentative area T1 corresponding to the rangefinding target R1, a tentative area T2 corresponding to the rangefinding target R2, and a tentative area T3 corresponding to the rangefinding target R3 onto the image captured by the imaging unit 105 in the first embodiment.

In FIG. 6, it is presumed that the imaged targets C1 and C2 are both of the same type. Here, it is presumed that the imaged targets C1 and C2 are both a vehicle (front).

As illustrated in FIG. 6, the tentative areas T1, T2, and T3 each correspond to a vehicle (front), but their sizes differ in accordance with the distances at which the rangefinding targets R1, R2, and R3 are detected. The size of a tentative area can be calculated by converting the size in the tentative value table 113a in accordance with the size of the image and the distance to the rangefinding target. That is, the sizes of the tentative areas T1, T2, and T3 are the sizes determined by presuming that the targets having the sizes in the tentative value table 113a are captured in the image at the respective distances.

For the imaged targets C1 and C2, the outer frames of the targets included in the image may be detected, or the outer frames of the imaged targets C1 and C2 may be approximated by squares.

The match-probability calculating unit 115 then calculates the match probability to be a higher value for a larger dimension of the overlap between the target imaged target and the tentative area.

Here, the match-probability calculating unit 115 calculates the match probability by the following equation (1).

$$\frac{R ∩ C}{C}$$

where R is the area or width of the tentative area in the captured image, and C is the area or width of the target imaged target in the captured image. If R is the area of the tentative area, then C is also the area of the target imaged target, and if R is the width of the tentative area, then C is also the width of the imaging area.

The numerator of the equation (1) i s the area or width of the overlap between the area or width of the tentative area and the area and width of the target imaged target in the captured image.

Thus, in the equation (1), the dimension of the overlap between the tentative area and the target imaged target in the captured image is divided by the dimension of the target imaged target in the captured image.

For example, in the example of FIG. 6, when the target imaged target is the imaged target C1, the match probability is calculated on the basis of the dimension of the imaged target C1 and the dimension of each of the tentative areas T1, T2, and T3.

When the target imaged target is the imaged target C2, the match probability is calculated on the basis of the dimension of the imaged target C2 and the dimension of each of the tentative areas T1, T2, and T3.

Referring back to FIG. 3, the combination-target determining unit 116 specifies, for each target imaged target, the rangefinding target having the highest match probability calculated by the match-probability calculating unit 115 as the combination target to be combined with the corresponding target imaged target. The rangefinding target specified as the combination target is also referred to as a target rangefinding target.

The combining unit 117 combines the distance and direction of the target imaged target indicated by the imaging information with the distance and direction indicated by the target rangefinding target, and outputs combined values.

Here, the method of combination may be a known method; for example, one of the distance indicated by the imaging information and the distance indicated, by the target rangefinding target or one of the direction indicated by the imaging information and the direction indicated by the target rangefinding target may be selected. Alternatively, the distance indicated by the imaging information and the distance indicated by the target rangefinding target may be added or multiplied with predetermined weighting, or the direction indicated by the imaging information and the direction indicated by the target rangefinding target may be added or multiplied with predetermined weighting.

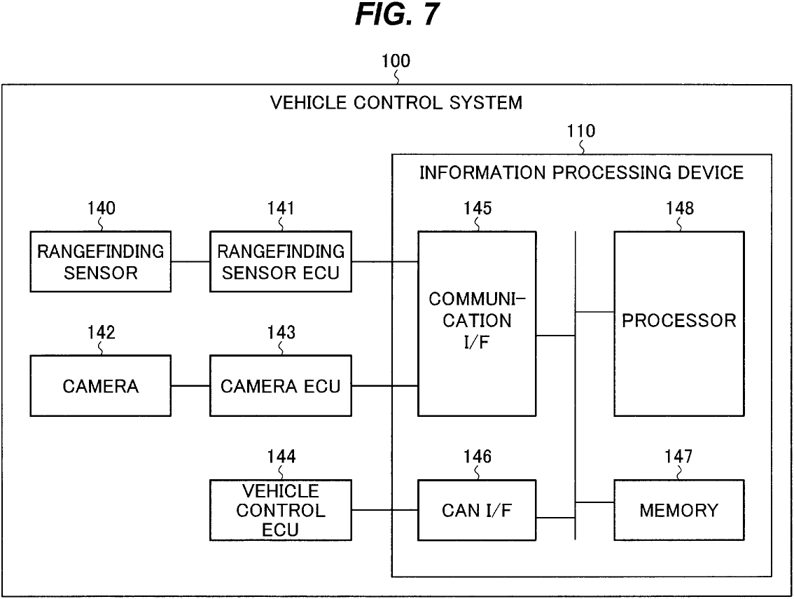

FIG. 7 is a block diagram illustrating a hardware configuration example of the vehicle control system 100 according to the first embodiment.

The vehicle control system 100 includes a rangefinding sensor 140, a rangefinding sensor electronic control unit (ECU) 141, a camera 142, a camera ECU 143, a vehicle control ECU 144, and an information processing device 110.

The information processing device 110 includes a communication I/F 145, a controller area network (CAN) I/F 146, a memory 147, and a processor 148.

The rangefinding unit 102 illustrated in FIG. 1 is implemented by the rangefinding sensor 140. The rangefinding sensor 140 is, for example, a millimeter-wave radar including a transmitting antenna that transmits millimeter waves and a receiving antenna that receives millimeter waves, or a light detection and ranging (LiDAR) sensor that performs rangefinding using laser light.

The rangefinding control unit 103 illustrated in FIG. 1 is implemented by the rangefinding sensor ECU 141.

The imaging unit 105 illustrated in FIG. 1 is implemented by the camera 142 serving as an imaging device.

The imaging control unit 106 illustrated in FIG. 1 is implemented by the camera ECU 143.

The vehicle control unit 107 illustrated in FIG. 1 is implemented by the vehicle control ECU 144.

The communication I/F unit 111 illustrated in FIG. 1 is implemented by the communication I/F 145.

The in-vehicle NW I/F unit 112 illustrated in FIG. 1 is implemented by the CAN I/F 146.

The storage unit 113 illustrated in FIG. 1 is implemented by the memory 147.

The control unit 114 illustrated in FIG. 1 can be implemented by the processor 148, such as a central processing unit (CPU), executing programs stored in the processing unit (CPU), programs stored in the memory 147. Such programs may be provided via a network or may be recorded and provided on a recording medium. That is, such programs may be provided as, for example, program products.

As described above, the information processing device 110 can be implemented by a computer. Alternatively, the information processing device 110 can be implemented by the communication I/F 145, the CAN I/F 146, and processing circuitry (not illustrated).

In other words, the vehicle control system 100 can be implemented by a sensor, an imaging device, and processing circuitry.

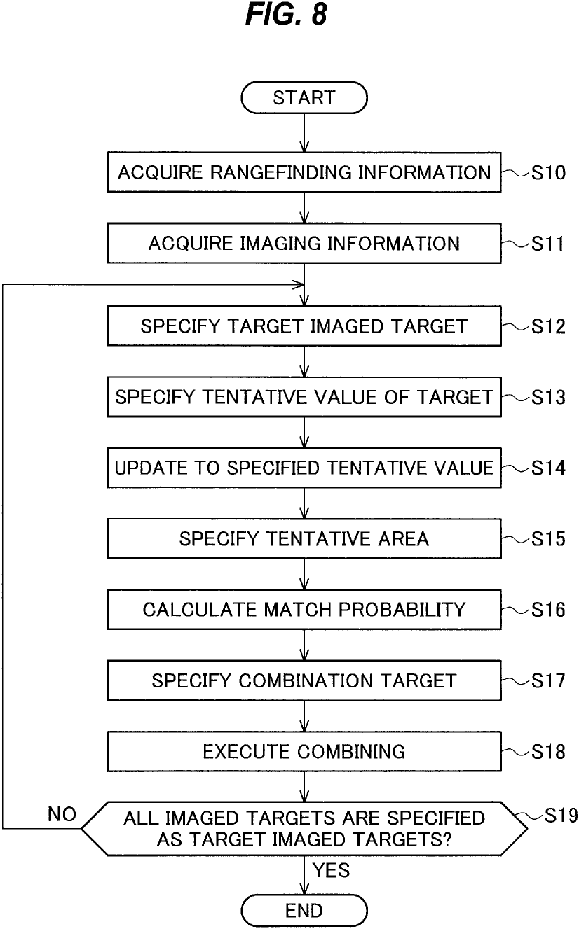

FIG. 8 is a flowchart illustrating the process executed in the information processing device 110 according to the first embodiment.

The communication I/F unit 111 acquires rangefinding information from the rangefinding and processing unit 101 (step S10). The acquired rangefinding information is given to the control unit 114.

The communication I/F unit 111 acquires imaging information and image data from the imaging and processing unit 104 (step S11). The acquired imaging information and image data are given to the control unit 114.

The match-probability calculating unit 115 specifies an imaged target as a target imaged target from the image targets indicated by the provided imaging information (step S12) .

The match-probability calculating unit 115 then refers to the provided imaging information to specify the type corresponding to the specified target imaged target, and specifies the width and height, which are tentative values, corresponding to the specified type stored in the storage unit 113 (step S13).

The match-probability calculating unit 115 specifies the size of the rangefinding target by applying the width and height specified in step S13 to the rangefinding target indicated by the rangefinding information acquired in step S10 (step S14) .

The match-probability calculating unit 115 positions the rangefinding target having the size specified in step S14 in accordance with the corresponding direction and distance indicated by the rangefinding information in the image indicated by the image data acquired in step S11, to specify a tentative area of the rangefinding target in the image (step S15) .

The match-probability calculating unit 115 calculates the match probability for each rangefinding target from the dimension of the overlap between the target imaged target in the image and the tentative area of the rangefinding target (step S16) .

Subsequently, the combination-target determining unit 116 specifies the rangefinding target having the highest possibility of matching the target imaged target from the match probability calculated in step S16 as a target rangefinding target, which is a combination target (step S17).

Subsequently, the combining unit 117 combines the distance and direction of the target imaged target and the distance and direction of the target rangefinding target to generate output values (step S18).

The match-probability calculating unit 115 then determines whether or not every imaged target indicated by the imaging information has been specified as a target imaged target (step S19). If every imaged target has been specified as a target imaged target (Yes in step S19), the process ends; if an unspecified imaged target remains (No in step S19) , the process returns to step S12. In step S12, the match-probability calculating unit 115 specifies an imaged target that h a s not yet been specified as a target imaged target, as a target imaged target.

The order of steps S10 and S11 in the process may be switched.

According to the first embodiment as described above, since the type of a target is specified from a captured image, the size of a target whose distance was measured is specified on the basis of the specified type, and the size can be changed in accordance with the measured distance, whether the targets match or not can be appropriately determined on the basis of a measured distance. This can reduce determination errors in determining the identity of the target. For example, when the size of the target included in the image in the measured direction is used as the size of the article whose distance has been measured, the overlap suddenly changes when lost or occlusion occurs in the angle of view of the imaging unit 105. However, such sudden change in overlap can be prevented by specifying the size on the basis of the type identified from the image.

### Second Embodiment

As illustrated in FIG. 1, a vehicle control system 200 according to the second embodiment includes a rangefinding and processing unit 101, an imaging and processing unit 104, a vehicle control unit 107, and an information processing device 210.

The rangefinding and processing unit 101, the imaging and processing unit 104, and the vehicle control unit 107 of the vehicle control system 200 according to the second embodiment are respectively the same as the rangefinding and processing unit 101, the imaging and processing unit 104, and the vehicle control unit 107 of the vehicle control system 100 according to the first embodiment.

The information processing device 210 includes a communication I/F unit 111, an in-vehicle NW I/F unit 112, a storage unit 113, and a control unit 214.

The communication I/F unit 111, the in-vehicle NW I/F unit 112, and the storage unit 113 of the information processing device 210 according to the second embodiment are respectively the same as the communication I/F unit 111, the in-vehicle NW I/F unit 112, and the storage unit 113 of the information processing device 110 according to the first embodiment.

The control unit 214 controls the processing executed in the information processing device 210. For example, the control unit 214 determines whether or not the target indicated by the rangefinding information provided by the rangefinding and processing unit 101 is identical to the target indicated by the imaging information provided by the imaging and processing unit 104, and when they are identical, the distance and direction indicated by the rangefinding information are combined with the distance and direction indicated by the imaging information.

As illustrated in FIG. 3, the control unit 214 includes a match-probability calculating unit 215, a combination-target determining unit 116, and a combining unit 117.

The combination-target determining unit 116 and the combining unit 117 of the control unit 214 according to the second embodiment are respectively the same as the combination-target determining unit 116 and the combining unit 117 of the control unit 114 according to the first embodiment.

The match-probability calculating unit 215 calculates match probability indicating the possibility that the target indicated by the rangefinding information and the target indicated by the imaging information match. The match-probability calculating unit 215 according to the second embodiment employs a method of calculating the match probability that differs from that employed by the match-probability calculating unit 115 according to the first embodiment.

In the second embodiment, the match-probability calculating unit 215 calculates match probability that increases as the dimension of the overlap between each of the tentative areas and the target area increases and as the distance to each of the rangefinding targets approximates the distance to the imaged target.

Here, the match-probability calculating unit 215 calculates the match probability by using the following equation (2) .

$$α \left(\frac{R ∩ C}{C}\right) + β \left(1 - \frac{\left|R \_ C - R \_ R\right|}{R \_ R}\right)$$

where R_C is a distance to a target imaged target, and R_R is a distance to a rangefinding target. And, α and β are weighting factors that are predetermined.

For example, the case where the target indicated by the rangefinding information and the target indicated by the imaging information are positioned as illustrated in FIG. 4 will be described.

When the target imaged target is the imaged target C2, R_C is the distance to the imaged target C2, which is included in the imaging information. R R is the distance to each of the rangefinding targets R1, R2, and R3, which are included in the rangefinding information.

In the second embodiment as described above, since the value corresponding to the distance to the detected target is added to the value for determining whether the targets match or not, it is possible to more appropriately determine whether the targets match or not. This can reduce determination errors in determining the identity of the target.

### Third Embodiment

As illustrated in FIG. 1, a vehicle control system 300 according to the third embodiment includes a rangefinding and processing unit 101, an imaging and processing unit 104, a vehicle control unit 107, and an information processing device 310.

The rangefinding and processing unit 101, the imaging and processing unit 104, and the vehicle control unit 107 of the vehicle control system 300 according to the third embodiment are repectively the same as the rangefinding and processing unit 101, the imaging and processing unit 104, and the vehicle control unit 107 of the vehicle control system 100 according to the first embodiment.

The information processing device 310 includes a communication I/F unit 111, an in-vehicle NW I/F unit 112, a storage unit 113, and a control unit 314.

The communication I/F unit 111, the in-vehicle NW I/F unit 112, and the storage unit 113 of the information processing device 310 according to the third embodiment are respectively the same as the communication I/F unit 111, the in-vehicle NW I/F unit 112, and the storage unit 113 of the information processing device 110 according to the first embodiment.

The control unit 314 controls the processing executed in the information processing device 310. For example, the control unit 314 determines whether or not the target indicated by the rangefinding information provided by the rangefinding and processing unit 101 is identical to the target indicated by the imaging information provided by the imaging and processing unit 104, and when they are identical, the distance and direction indicated by the rangefinding information are combined with the distance and direction indicated by the imaging information.

As illustrated in FIG. 3, the control unit 314 includes a match-probability calculating unit 315, a combination-target determining unit 116, and a combining unit 117.

The combination-target determining unit 116 and the combining unit 117 of the control unit 314 according to the third embodiment are respectively the same as the combination-target determining unit 116 and the combining unit 117 of the control unit 114 according to the first embodiment.

The match-probability calculating unit 315 calculates match probability indicating the possibility that the target indicated by the rangefinding information and the target indicated by the imaging information match. The match-probability calculating unit 315 according to the third embodiment employs a method of calculating the match probability that differs from that employed by the match-probability calculating unit 115 according to the first embodiment.

In the third embodiment, the match-probability calculating unit 315 calculates match probability that increases as the dimension of the overlap between each of the tentative areas and the target area increases and as the distance between the imaged target to each of the tentative areas decreases when multiple rangefinding targets are projected onto the image indicated by the image data.

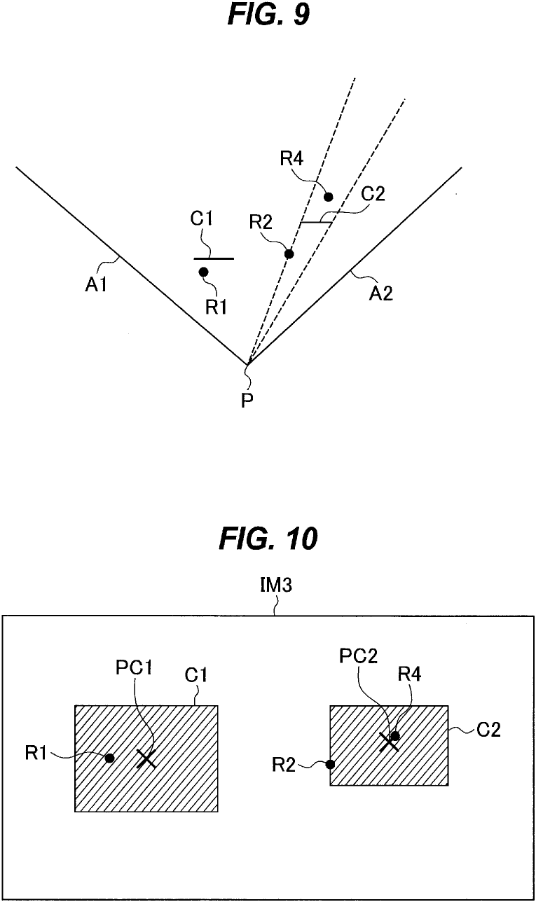

FIG. 9 is a schematic diagram for explaining targets indicated by rangefinding information and targets indicated by imaging information in the third embodiment.

FIG. 9 is a top-view diagram of a range of an image captured by the imaging unit 105, rangefinding targets, and imaged targets.

An image of an imaging range A1 to A2 having a certain angle of view relative to a lens position P, which is the position of the lens in the imaging unit 105, is captured.

The imaging range A1 to A2 includes imaged targets C1 and C2.

In the imaging range A1 to A2, rangefinding targets R1, R2, and R4 are detected.

Under the circumstances described above, the match-probability calculating unit 315 calculates the match probability for each imaged target to specify a matching rangefinding target.

Specifically, the match-probability calculating unit 315 specifies the type of the target imaged target from the imaging information and specifies the size corresponding to the specified type from the tentative value table 113a.

On the basis of the specified size, the match-probability calculating unit 315 projects a tentative area corresponding to the rangefinding target onto the image captured by the imaging unit 105 in a size corresponding to the distance of the rangefinding target. The processing up to this point is the same as that performed by the match-probability calculating unit 115 according to the first embodiment.

Subsequently, the match-probability calculating unit 315 calculates the distance from the target imaged target to each of the rangefinding targets.

FIG. 10 is a schematic diagram illustrating an image IM3 obtained by projecting rangefinding targets R1, R2, and R4 onto an image captured by the imaging unit 105 in the third embodiment.

The image captured by the imaging unit 105 captures imaged targets C1 and C2, and the rangefinding targets R1, R2 and R4 are projected onto the image in the directions indicated by the rangefinding information.

For example, when the target imaged target is the imaged target C1, the match-probability calculating unit 315 calculates the distance from a center point PC1, which is a predetermined point in the image target C1, to each of the ranging targets R1, R2, and R4.

When the target imaged target is the imaged target C2, the match-probability calculating unit 315 calculates the distance from a center point PC2, which is a predetermined point in the imaged target C2, to each of the ranging targets R1, R2, and R4. Here, the predetermined point is a center point, but alternatively, the predetermined point may be, for example, the center of gravity or other points.

The match-probability calculating unit 315 then calculates match probability that increases as the dimension of the overlap between the target imaged target and the tentative area and as the distance to the target imaged target decreases.

Here, the match-probability calculating unit 315 calculates the match probability by using the following equation (3).

$$α \left(\frac{R ∩ C}{C}\right) + γ \left(\frac{\left|\text{u\_C} - \text{u\_R}\right|}{{\text{u}}_{\text{Max}} - {\text{u}}_{\text{Min}} + 1}\right)$$

where u_C is the pixel position of a predetermined point of the target imaged target in the image, and u_R is the pixel position of the rangefinding target. And, |u_C-u_R| is the number of pixels (distance) between the target imaged target and the rangefinding target.

And, u_{Max} is the leftmost pixel position of the image, u_{Min} is the rightmost pixel position of the image, and u_{Max}-u_{Min+1} is the number of pixels (length) in the lateral direction of the image.

In the third embodiment as described above, since the value corresponding to the distance to the target in the captured image is added to the value for determining whether the targets match or not, it is possible to more appropriately determine whether the targets match or not. This can reduce determination errors in determining the identity of the target.

### Fourth Embodiment

As illustrated in FIG. 1, a vehicle control system 400 according to the fourth embodiment includes a rangefinding and processing unit 101, an imaging and processing unit 104, a vehicle control unit 107, and an information processing device 410.

The rangefinding and processing unit 101, the imaging and processing unit 104, and the vehicle control unit 107 of the vehicle control system 400 according to the fourth embodiment are respectively the same as the rangefinding and processing unit 101, the imaging and processing unit 104, and the vehicle control unit 107 of the vehicle control system 100 according to the first embodiment.

The in for informationprocessing device 410 includes a communication I/F unit 111, an in-vehicle NW I/F unit 112, a storage unit 113, and a control unit 414.

The communication I/F unit 111, the in-vehicle NW I/F unit 112, and the storage unit 113 of the information processing device 410 according to the fourth embodiment are respectively the same as the communication I/F unit 111, the in-vehicle NW I/F unit 112, and the storage unit 113 of the information processing device 110 according to the first embodiment.

The control unit 414 controls the processing executed in the information processing device 410. For example, the control unit 414 determines whether or not the target indicated by the rangefinding information provided by the rangefinding and processing unit 101 is identical to the target indicated by imaging information provided by the imaging and processing unit 104, and when they are identical, the distance and direction indicated by the rangefinding information are combined with the distance and direction indicated by the imaging information.

FIG. 11 is a block diagram schematically illustrating a configuration of the control unit 414 according to the fourth embodiment.

The control unit 414 includes a match-probability calculating unit 415, a combination-target determining unit 116, a combining unit 117, and a confidence-level calculating unit .

The combination-target determining unit 116 and the combining unit 117 of the control unit 414 according to the fourth embodiment are respectively the same as the combination-target determining unit 116 and the combining unit 117 of the control unit 114 according to the first embodiment.

The confidence-level calculating unit 418 calculates the distance and direction of the imaged target indicated by the imaging information and the confidence level of the distance and direction of each of the rangefinding targets indicated by the rangefinding information.

For example, the confidence-level calculating unit 418 uses a Kalman filter to calculate the direction and distance of the target imaged target and the direction and distance of the each of the rangefinding targets as detection items.

Specifically, the confidence-level calculating unit 418 acquires the direction and distance of the target imaged target as observed values. The confidence-level calculating unit 418 acquires the direction and distance of each of the rangefinding targets indicated by the rangefinding information as observed values.

The confidence-level calculating unit 418 then uses the observed values as input to calculate detected values of the respective detection items by using a Kalman filter.

For example, the confidence-level calculating unit 418 calculates detected values for the detection items by using a Kalman filter for a motion model of a target represented by the equation (4) below and an observation model of a target represented by the equation (5) below.

$${X}_{t \left|t - 1\right)} = {F}_{t \left|t - 1\right)} ⋅ {X}_{t - 1 \left|t - 1\right)} + {G}_{t \left|t - 1\right)} ⋅ {U}_{t - 1}$$

$${Z}_{t} = {H}_{t} ⋅ {X}_{t \left|t - 1\right)} + {V}_{t}$$

Here, X_{t|t-1} is a state vector of time t at time t-1. F_{t|t-1} is a transition matrix from time t-1 to time t. X_{t-1|t-1} is a current value of the state vector of the target at time t-1. G_{t|t-1} is a driving matrix from time t-1 to time t. Uₜ₋₁ is a system noise vector whose mean at time t-1 is zero and which follows a normal distribution of the covariance matrix Qₜ₋₁. Zₜ is an observation vector indicating the observed value at time t. Hₜ is an observation function at time t. Vₜ is an observation noise vector whose mean at time t is zero and which follows a normal distribution of the covariance matrix Rₜ.

When an extended Kalman filter is used, the confidence-level calculating unit 418 calculates the detected values by executing the prediction processing represented by the following equations (6) and (7) and the smoothing processing represented by the following equations (8) to (13) for the detection items.

$${\hat{X}}_{t \left|t - 1\right)} = {F}_{t \left|t - 1\right)} ⋅ {\hat{X}}_{t - 1 \left|t - 1\right)}$$

$${P}_{t \left|t - 1\right)} = {F}_{t \left|t - 1\right)} ⋅ {P}_{t - 1 \left|t - 1\right)} ⋅ {F}_{t \left|t - 1\right)} {}^{T} + {G}_{t \left|t - 1\right)} ⋅ {Q}_{t - 1} ⋅ {G}_{t \left|t - 1\right)} {}^{T}$$

$${S}_{t} = {H}_{k} ⋅ {P}_{t \left|t - 1\right)} ⋅ {H}_{k} {}^{T} + {R}_{t}$$

$${\tilde{Z}}_{t} = {Z}_{t} - {H}_{t} ⋅ {\hat{X}}_{t \left|t - 1\right)}$$

$${θ}_{t} = \sqrt{{\tilde{Z}}_{t} {}^{T} {S}_{t}^{- 1} {\tilde{Z}}_{t}}$$

$${K}_{t} = {P}_{t \left|t - 1\right)} ⋅ {H}_{t} {}^{T} ⋅ {S}_{t}^{- 1}$$

$${\hat{X}}_{t \left|t\right)} = {\hat{X}}_{t \left|t - 1\right)} + {K}_{t} ⋅ {\tilde{Z}}_{t}$$

$${P}_{t \left|t\right)} = \left(\text{Ι} - {K}_{t} ⋅ {H}_{t}\right) ⋅ {P}_{t \left|t - 1\right)}$$

Here, X^_{t|t-1} is a prediction vector of time t at time t-1. X^_{t-1|t-1} is a smooth vector at time t-1. P_{t|t-1} is a prediction-error covariance matrix of time t at time t-1. P_{t-1|t-1} is a smooth-error covariance matrix of time t-1. Sₜ is a residual covariance matrix of time t. St is a Mahalanobis distance of time t. Kt is a Kalman gain of time t. X^_{t|t} is a smooth vector of time t and indicates a detected value of each detection item of time t. P_{t|t} is a smooth-error covariance matrix of time t. I is an identity matrix. The character T superscripted on the matrix indicates a transposed matrix, and the character -1 indicates an inverse matrix.

The confidence-level calculating unit 418 writes, into the storage unit 113, various kinds of data obtained through calculation, such as Mahalanobis distance θₜ, Kalman gain Kₜ, and smooth vector X^_{t|t} of time t.

The confidence-level calculating unit 418 then calculates the Mahalanobis distance of the corresponding time between the observed values of the rangefinding targets obtained from the rangefinding information and the observed value of the target imaged target obtained from the imaging information. Here, the method of calculating the Mahalanobis distance differs from the above-described method of calculating the Mahalanobis distance only in the data to be calculated.

When the Mahalanobis distance is less than or equal to a threshold value, the confidence-level calculating unit 418 determines that the observed values obtained from the rangefinding information and the imaging information are observed values obtained by observing the same object and classifies these observed values into the same group.

Subsequently, the confidence-level calculating unit 418 calculates the confidence level of the detected value of a target detection item calculated as described above by using each of the detection items a s the target detection item.

Specifically, the confidence-level calculating unit 418 acquires the Mahalanobis distance between the observed values and a predicted value. The observed values are the values of a target detected item obtained from the rangefinding information and the imaging information. The predicted value is the value used in the calculation of the above detected value and the value of the detection item of the object at the target time, predicted at a time before the target time. That is, while X^_{t|t} is being calculated, the confidence-level calculating unit 418 acquires the Mahalanobis distance θₜ calculated as described above by reading it from the storage unit 113.

The confidence-level calculating unit 418 acquires the Kalman gain obtained during the above-described calculation of the detected value. That is, while X^_{t|t} is being calculated, the confidence-level calculating unit 418 acquires the calculated Kalman gain Kₜ by reading it from the storage unit 113.

The confidence-level calculating unit 418 then uses the Mahalanobis distance θₜ and the Kalman gain Kₜ to calculate the confidence level of the detected value of the target detection item calculated on the basis of the observed values obtained from the rangefinding information and the imaging information. Specifically, the confidence-level calculating unit 418 calculates the confidence level of the detected value of the target detection item by multiplying the Mahalanobis distance θₜ by the Kalman gain Kₜ as in the following equation (14).

$$\left[\begin{matrix}{M}_{X} \\ {M}_{Y}\end{matrix}\right] = \left[\begin{matrix}{K}_{X} \\ {K}_{Y}\end{matrix}\right] \left[\begin{matrix}{θ}_{t} \\ {θ}_{t}\end{matrix}\right]$$

Here, Mₓ is the confidence level for the direction X, and M_{Y} is the confidence level for the distance Y. Kₓ is the Kalman gain for the direction X, and K_{Y} is the Kalman gain for the distance Y.

The confidence-level calculating unit 418 may calculate the confidence level by multiplying the Mahalanobis distance θₜ by the Kalman gain Kₜ after weighting at least one of the Mahalanobis distance θₜ and the Kalman gain Kₜ.

The match-probability calculating unit 415 calculates the match probability when the confidence levels of all of the rangefinding targets are lower than a predetermined threshold.

Specifically, if the confidence level calculated as described above is higher than or equal to the confidence level functioning as a predetermined threshold, the match-probability calculating unit 415 selects, out of the multiple detected values calculated as described above, the detected value having the highest confidence level as the output value. A high confidence level means that the product of the Mahalanobis distance and the Kalman gain is small.

Here, the confidence level is used to select the detected value to be adopted from multiple detected values calculated on the basis of each observed value set as an observed value of detecting the same object. Thus, the confidence-level calculating unit 418 may calculate the confidence level on the basis of each observed value classified into a group as described above.

When the confidence level calculated by the confidence-level calculating unit 418 is lower than the confidence level functioning as a predetermined threshold, the match-probability calculating unit 415 calculates the match probability as in the first embodiment.

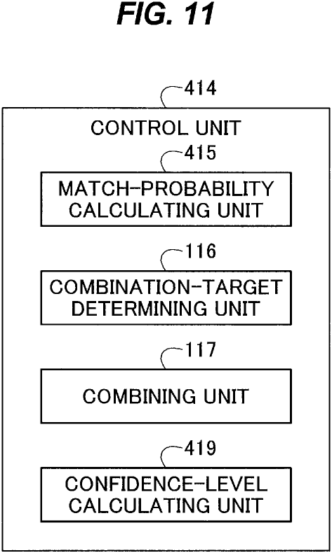

FIG. 12 is a flowchart illustrating the process executed in the information processing device 410 according to the fourth embodiment.

The communication I/F unit 111 acquires rangefinding information from the rangefinding and processing unit 101 (step S20). The acquired rangefinding information is given to the control unit 414.

The communication I/F unit 111 acquires imaging information and image data from the imaging and processing unit 104 (step S21). The acquired imaging information and the image data are given to the control unit 414.

The match-probability calculating unit 415 specifies a target imaged target from the image targets indicated by the provided imaging information (step S22) .

The confidence-level calculating unit 418 then uses the direction and distance corresponding to the specified target imaged target and the direction and distance corresponding to the rangefinding target indicated by the rangefinding information as observed values, to calculates the confidence level (step S23).

The match-probability calculating unit 415 then determines whether or not all of the calculated confidence levels are lower than the threshold confidence level in at least one detection item (step S24). If all confidence levels in at least one detection item are less than the threshold confidence level (Yes in step S24), the process proceeds to step S25, and if at least one confidence level in all detection items is equal to or higher than the threshold confidence level (No in step S24), the process proceeds to step S31.

In step S25, the match-probability calculating unit 115 refers to the provided imaging information to specify the type corresponding to the specified target imaged target, and refers to the tentative value table 113a stored in the storage unit 113 to specify the width and height, which are tentative values, corresponding to the specified type.

The match-probability calculating unit 415 applies the width and height specified in step S25 to the rangefinding target indicated by the rangefinding information acquired in step S20, to specify the size of the rangefinding target (step S26).

The match-probability calculating unit 415 positions the rangefinding target having the size specified in step S26 in accordance with the corresponding direction and distance indicated in the rangefinding information in the image indicated by the image data acquired in step S21, to specify the tentative area of the rangefinding target in the image (step S27).

The match-probability calculating unit 415 calculates the match probability for each rangefinding target from the dimension of the overlap of the target imaged target and the tentative area of the rangefinding target in the image (step S28).

Subsequently, the combination-target determining unit 116 specifies a rangefinding target having the highest possibility of matching the target imaged target from the match probability calculated in step S28 as a target rangefinding target, which is a combination target (step S29).

Subsequently, the combining unit 117 combines the distance and direction of the target imaged target and the distance and direction of the target rangefinding target to generate output values (step S30). The process then proceeds to step S32.

In step S24, if at least one confidence level is equal to or higher than the threshold confidence level in all the detection items (No in step S24), the process proceeds to step S31, and in step S31, the match-probability calculating unit 415 specifies the detected value having the highest confidence level in each of the detection items as an output value. The process then proceeds to step S32.

In step S32, the match-probability calculating unit 415 determines whether or not all imaged targets indicated by the imaging information have been specified as target imaged targets. If every imaged target has been specified as a target imaged target (Yes in step S32), the process ends; if an unspecified imaged target remains (No in step , the process returns to step S22. In step S22, the match-probability calculating unit 415 specifies an imaged target that has not yet been specified as a target imaged target, as a target imaged target.

The order of steps S20 and S21 in the processing may be switched.

According to the fourth embodiment as described above, since only the detected value having a high confidence level can be directly used as an output value, determination errors in determining the identity of a target can be reduced.

In the fourth embodiment, the match-probability calculating unit 415 calculates the match probability as in the first embodiment when the confidence level of every rangefinding target is lower than a predetermined threshold; however, the fourth embodiment is not limited such an example. For example, the match-probability calculating unit 415 may calculate match probability as in the second or third embodiment.

### Fifth Embodiment

As illustrated in FIG. 1, a vehicle control system 500 according to the fifth embodiment includes a rangefinding and processing unit 101, an imaging and processing unit 104, a vehicle control unit 107, and an information processing device 510.

The rangefinding and processing unit 101, the imaging and processing unit 104, and the vehicle control unit 107 of the vehicle control system 500 according to the fifth embodiment are respectively the same as the rangefinding and processing unit 101, the imaging and processing unit 104, and the vehicle control unit 107 of the vehicle control system 100 according to the first embodiment.

The information processing device 510 includes a communication I/F unit 111, an in-vehicle NW I/F unit 112, a storage unit 113, and a control unit 514.

The communication I/F unit 111, the in-vehicle NW I/F unit 112, and the storage unit 113 of the information processing device 510 according to the fifth embodiment are respectively the same as the communication I/F unit 111, the in-vehicle NW I/F unit 112, and the storage unit 113 of the information processing device 110 according to the first embodiment.

The control unit 514 controls the processing executed in the information processing device 510. For example, the control unit 514 determines whether or not the target indicated by the rangefinding information provided by the rangefinding and processing unit 101 is identical to the target indicated by the imaging information provided by the imaging and processing unit 104, and when they are identical, the distance and direction indicated by the rangefinding information combined with the distance and direction indicated by the imaging information.

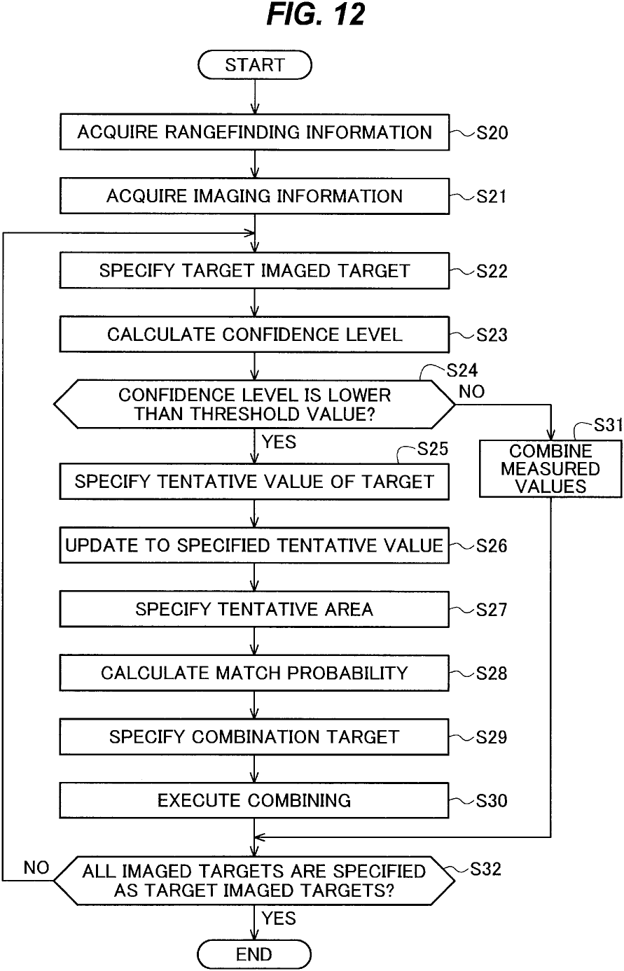

FIG. 13 is a block diagram schematically illustrating a configuration of the control unit 514 according to the fifth embodiment.

The control unit 514 includes a match-probability calculating unit 515, a combination-target determining unit 116, a combining unit 117, and a running-trajectory specifying unit 519.

The combination-target determining unit 116 and the combining unit 117 of the control unit 514 according to the fifth embodiment are respectively the same as the combination-target determining unit 116 and the combining unit 117 of the control unit 114 according to the first embodiment .

The running-trajectory specifying unit 519 specifies a running trajectory of a vehicle on which the vehicle control system 500 is mounted. The running-trajectory specifying unit 519 may specify a running trajectory by using a known method.

For example, the running-trajectory specifying unit; 519 can specify a running trajectory by specifying lines for distinguishing the lane where the vehicle is running in the image indicated by the image data from the imaging and processing unit 4 The running-trajectory specifying unit 519 may specify a running trajectory of the vehicle from the steering angle, the yaw rate, or the like of the vehicle indicated by the vehicle information obtained from the vehicle control unit 107.

The match-probability calculating unit 515 calculates the match probability between the imaged target and each of the rangefinding targets when the imaged target affects the running trajectory.

Specifically, the match-probability calculating unit 515 specifies, as an influencing imaged target, the imaged target that affects the running trajectory specified by the running-trajectory specifying unit 519 in the image indicated by the image data from the imaging and processing unit 104. For example, when at least a portion of a target included in the image is included in the running trajectory, the match-probability calculating unit 515 specifies the target as an influencing imaged target.

The match-probability calculating unit 515 then specifies a target imaged target from influencing imaged targets and calculates the match probability between the target imaged target and the rangefinding target. The processing here is the same as in the first embodiment.

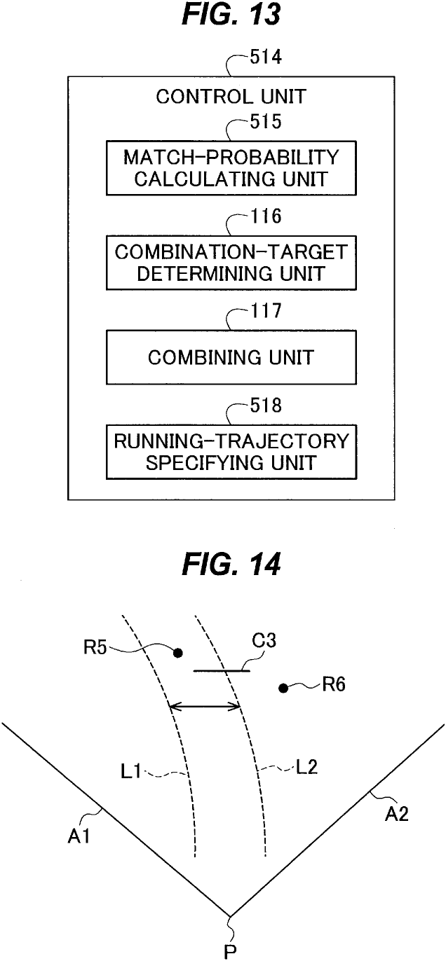

FIG. 14 is a schematic diagram for explaining a target indicated by rangefinding information and a target indicated by imaging information in the fifth embodiment.

FIG. 14 is a top-view diagram of a range of an image captured by the imaging unit 105, rangefinding targets, and an imaged target.

An image of an imaging range A1 to A2 having a certain angle of view relative to a lens position P, which is the position of the lens in the imaging unit 105, is captured.

The imaging range A1 to A2 includes an imaged target C3.

In the imaging range A1 to A2, rangefinding targets R5 and R6 are detected.

In FIG. 14, it is presumed that the running-trajectory specifying unit 519 detects a left lane line Ll and a right lane line L2 as the running trajectory of the vehicle.

Since the imaged target C3 partially overlaps the line L2, the imaged target C3 is an influencing imaged target.

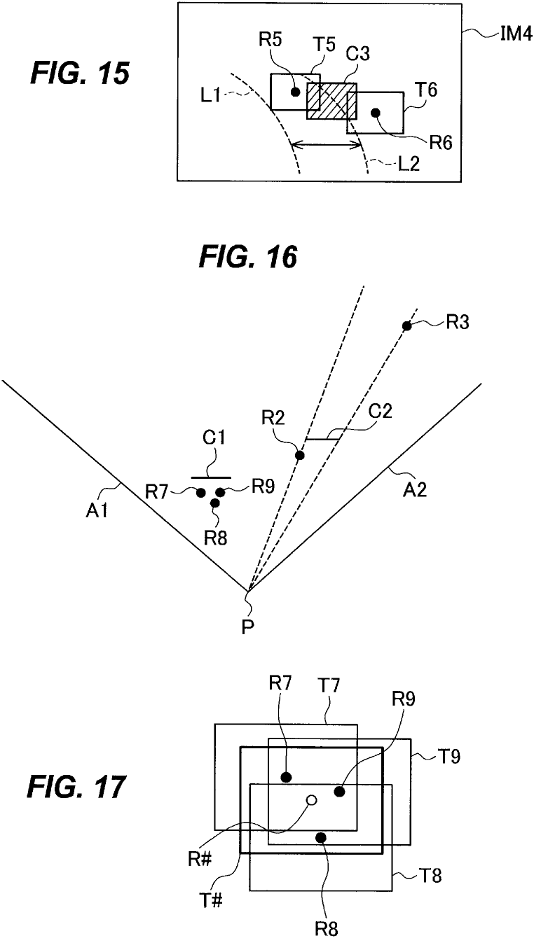

FIG. 15 is a schematic diagram illustrating an image IM4 obtained by projecting tentative area T5 corresponding to the rangefinding target R5 and a tentative area T6 corresponding to the rangefinding target R6 onto an image captured by the imaging unit 105 in the fifth embodiment.

In FIG. 15, it is presumed that the imaged target C3 as an influencing imaged target is a vehicle (front).

As illustrated in FIG. 15, the tentative areas T5 and T6 each correspond to a vehicle (front), but their sizes differ in accordance with the distances at which the rangefinding targets R5 and R6 are detected.

In the above situation, the match-probability calculating unit 515 calculates the match probability by using the dimension of the overlaps between the imaged target C3 specified as an influencing imaged target and the respective tentative areas T5 and T6.

According to the fifth embodiment as described above, it is possible to accurately detect a target affecting the running of the vehicle on which the vehicle control system. 500 is mounted, such as a preceding vehicle, or an object or person, on the running trajectory.

In the above-described fifth embodiment, an example in which the running-trajectory specifying unit 519 is added to the first embodiment is described; however, the fifth embodiment is not limited to such an example. For example, it is also possible to add the running-trajectory specifying unit 519 to any of the second to fourth embodiments.

In the above-described first to fifth embodiments, the match probability between each of the rangefinding target indicated in the rangefinding information and the target imaged target is calculated; however, the first to fifth embodiments are not limited to such an example. For example, multiple rangefinding targets may be combined to generate one tentative area. Specifically, when the distances to multiple rangefinding targets are smaller than or equal to a predetermined threshold or when multiple rangefinding targets are adjacent to each other, such as when the position of a rangefinding target is included in a tentative area of another rangefinding target in an image, the match-probability calculating units 115 to 515 can aggregate the rangefinding targets into a single rangefinding target. The rangefinding targets aggregated into one is also referred to as an aggregated rangefinding target.

In other words, when two or more rangefinding targets are adjacent to each other, the match-probability calculating units 115 to 515 may specify an aggregated rangefinding target obtained by aggregating the two or more rangefinding targets into one, and calculate the match probability between an imaged target and the aggregated rangefinding target.

FIG. 16 is a top-view diagram of a range of an image captured by the imaging unit 105, rangefinding targets, and imaged targets in a first modification of the first to fifth embodiments.

An image of an imaging range A1 to A2 having a certain angle of view relative to a lens position P, which is the position of the lens in the imaging unit 105, is captured.

The imaging range A1 to A2 includes imaged targets Cl and C2.

In the imaging range A1 to A2, rangefinding targets R2, R3, and R7 to R9 are detected.

FIG. 17 is a schematic diagram illustrating a tentative area T7 of a rangefinding target R7, a tentative area T8 of a rangefinding target R8, and a tentative area T9 of a rangefinding target R9 in the first modification.

In the example illustrated in FIG. 17, since the tentative area T9 of the rangefinding target R9 includes the other rangefinding targets R7 and R8, the match-probability calculating units 115 to 515 specify an aggregated rangefinding target R# that aggregates the rangefinding targets R7 to R9.

Here, the match-probability calculating units 115 to 515 use a central point, which is a representative point calculated from the rangefinding targets R7 to R9, as the aggregated rangefinding target R#, but the first modification is not limited to such an example. Any one of the rangefinding targets R7 to R9 to be aggregated, for example, the rangefinding target R9 including the other rangefinding targets R7 and R8 in a tentative area T9, may be selected as the aggregated rangefinding target.

The match-probability calculating units 115 to 515 may then calculate the match probability between the target imaged target and the aggregated rangefinding target R#.

According to the first modification as described above, when multiple rangefinding targets are detected from one article or one person, or when it is appropriate to treat multiple rangefinding targets, such as a bicycle and the person riding the bicycle, as one rangefinding target, multiple rangefinding targets can be aggregated into one. For the distance and direction of the aggregated rangefinding target, representative values such as the averages or medians of the distance and direction of the multiple aggregated rangefinding targets may be used.

In the above-described first to fifth embodiments, if the distance to a rangefinding target is too small, the tentative area of the rangefinding target may be too large. An example of dealing with such a case is presented as a second modification.

For example, in the second modification, when the distance to at least one of the rangefinding targets is smaller than a predetermined threshold distance, the match-probability calculating units 115 to 515 can prevent the match probability from being calculated between the imaged target and the at least one of the rangefinding targets. This will be descried below.

FIG. 18 is a top-view diagram of a range of an image captured by the imaging unit 105, rangefinding targets, and imaged targets in a second modification of the first to fifth embodiments.

An image of an imaging range A1 to A2 having a certain angle of view relative to a lens position P, which is the position of the lens in the imaging unit 105, is captured.

The imaging range A1 to A2 includes imaged targets C1 and C2.

In the imaging range A1 to A2, rangefinding targets R1, R2, R3, and R10 are detected. The rangefinding target R10 is detected at a position very close to the lens position P.

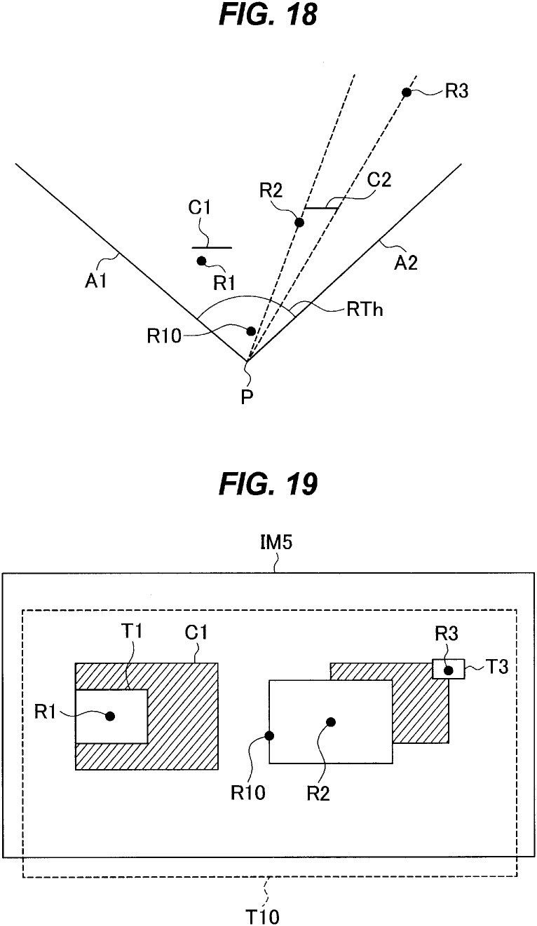

FIG. 19 is a schematic diagram illustrating an image IM5 obtained by projecting a tentative area T1 corresponding to the rangefinding target R1, a tentative area T2 corresponding to the rangefinding target R2, a tentative area T3 corresponding to the rangefinding target R3, and a tentative a rea T10 corresponding to the rangefinding target R10 onto an image captured by the imaging unit 105 in the second modification.

In FIG. 19, also, it is presumed that the type of both the imaged targets C1 and C2 is a vehicle (front).

As illustrated in FIG. 19, since the rangefinding target R10 is detected at a very close distance, its tentative area T10 is very large, so that the match probabilities of the imaged targets C1 and C2 and the rangefinding targets R1 to R3 cannot be appropriately calculated.

Therefore, in the second modification, for example, a threshold distance RTh is determined as a threshold in advance, as illustrated in FIG. 18. The match-probability calculating units 115 to 515 then do not calculate the match probability with the target imaged target for the rangefinding target whose distance indicated by the rangefinding information is smaller than the threshold distance RTh.

According to the second modification as described above, the match probability can be appropriately calculated even when the distance to a rangefinding target is too small to calculate the match probability appropriately. The second modification is effective, for example, when an error also occurs in the rangefinding by the rangefinding and processing unit 101.

Although the output values combined by the combining units 117 and 417 are output in the above-described first to fifth embodiments, the first to fifth embodiments are not limited to such an example. For example, the match probabilities calculated by the match-probability calculating units 115 to 515 may be output. In such a case, the combination-target determining units 116 and 416 and the combining units 117 and 417 can be omitted.

### DESCRIPTION OF REFERENCE CHARACTERS

100, 200, 300, 400, 500 vehicle control system; 101 rangefinding and processing unit; 102 rangefinding unit; 103 rangefinding control unit; 104 imaging and processing unit; 105 imaging unit; 106 imaging control unit; 107 vehicle control unit; 110, 210, 310, 420, 510 information processing device; 111 communication I/F unit; 112 in-vehicle NW I/F unit; 113 storage unit; 114, 214, 314, 414, 514 control unit; 115, 215, 315, 415, 515 match-probability calculating unit; 116, 416 combination-target determining unit; 117, 417 combining unit; 418 confidence-level calculating unit; 519 running-trajectory specifying unit.

What is claimed is:

1. An information processing system comprising:
a sensor to detect distance to each of a plurality of rangefinding targets, the rangefinding targets being targets present in a detection range;
an imaging device to capture an image with at least a portion of an imaging range overlapping the detection range and generate image data indicating the image; and
processing circuitry
to generate rangefinding information indicating the distance and direction to each of the rangefinding targets based on a result of detection by the sensor;
to specify distance, direction, and type of an imaged target, and generate imaging information distance, direction, and type of the imaged target, the imaged target being a target included in the image; and
to specify tentative values indicating sizes of the rangefinding targets by using the imaging information, specify a plurality of tentative areas in accordance with the tentative values and the rangefinding information, and calculate match probability indicating possibility of the imaged target matching each of the rangefinding targets by using a dimension of an overlap between each of the tentative areas and a target area, the tentative areas being areas where the rangefinding targets are projected onto the image, the target area being an area in the image capturing the imaged target.

2. The information processing system according to claim 1, wherein the processing circuitry calculates the match probability in such a manner that the match probability increases as a dimension of an overlap between each of the tentative areas and the target area increases.

3. The information processing system according to claim 2, wherein the processing circuitry calculates the match probability in such a manner that the match probability increase as an area of the overlap between each of the tentative areas and the target area increases.

4. The information processing system according to claim 2, wherein the processing circuitry calculates the match probability in such a manner that the match probability increases as a width of the overlap between each of the tentative areas and the target area increases.

5. The information processing system according to claim 1, wherein the processing circuitry calculates the match probability in such a manner that the match probability increases as a dimension of an overlap between each of the tentative areas and the target area increases and as a distance to each of the rangefinding targets approximates a distance to the imaged target.

6. The information processing system according to claim 1, wherein the processing circuitry calculates the match probability in such a manner that the match probability increases as a dimension of an overlap between each of the tentative areas and the target area increases and as a distance between the imaged target and each of the tentative areas decreases when the rangefinding targets are projected onto the image.

7. The information processing system according to claim 1, wherein the processing circuitry calculates confidence levels of distance and direction of the imaged target indicated by the imaging information and distance and direction of each of the rangefinding targets indicated by the rangefinding information, and calculates the match probability when the confidence levels of all of the rangefinding targets are lower than a predetermined threshold.

8. The information processing system according to claim 1, wherein the processing circuitry specifies a running trajectory of a vehicle on which the information processing system is mounted, and calculates the match probability between the imaged target and each of the rangefinding targets when the imaged target affects the running trajectory.

9. The information processing system according to claim 1, wherein the processing circuitry determines a rangefinding target having the highest match probability out of the plurality of rangefinding targets, as a combination target, and combines distance and direction of the rangefinding target and distance and direction of the combination target.

10. The information processing system according to claim 1, wherein the processing circuitry specifies the tentative value corresponding to a type included in the imaging information.

11. The information processing system according to claim 1, wherein when two or more rangefinding targets out of the plurality of rangefinding targets are adjacent to each other, the processing circuitry specifies an aggregated rangefinding target obtained by aggregating the two or more rangefinding targets into one, and calculates the match probability between the imaged target and the aggregated rangefinding target.

12. The information processing system according to claim 1, wherein when a distance to at least one of the rangefinding targets is smaller than a predetermined threshold distance, the processing circuitry prevents the match probability from being calculated between the imaged target and the at least one of the rangefinding targets.

13. An information processing device comprising:
a communication interface to acquire rangefinding information, image data, and imaging information, the rangefinding information indicating distance and direction of each of a plurality of rangefinding targets, the rangefinding targets being targets present in a detection range, the image data indicating an image captured by overlapping at least a portion of an imaging range with the detection range, the imaging information indicating distance, direction, and type of an imaged target, the imaged target being a target included in the image; and
processing circuitry to specify tentative values indicating sizes of the rangefinding targets by using the imaging information, specify a plurality of tentative areas in accordance with the tentative values and the rangefinding information, and calculate match probability indicating possibility of the imaged target matching each of the rangefinding targets by using a dimension of an overlap between each of the tentative areas and a target area, the tentative areas being areas where the rangefinding targets are projected onto the image, the target area being an area in the image capturing the imaged target.

14. A non-transitory computer-readable storage medium storing a program that causes a computer to execute processing comprising:
acquiring rangefinding information, image data, and imaging information, the rangefinding information indicating distance and direction of each of a plurality of rangefinding targets, the rangefinding targets being targets present in a detection range, the image data indicating an image captured by overlapping at least a portion of an imaging range with the detection range, the imaging information indicating distance, direction, and type of an imaged target, the imaged target being a target included in the image;
specifying tentative values indicating sizes of the rangefinding targets by using the imaging information;
specifying a plurality of tentative areas in accordance with the tentative values and the rangefinding information, the tentative areas being areas where the rangefinding targets are projected onto the image; and
calculating match probability indicating possibility of the imaged target matching each of the rangefinding targets by using a dimension of an overlap between each of the tentative areas and a target area, the target area being an area in the image capturing the imaged target.

15. An information processing method comprising:
detecting distance and direction to each of a plurality of rangefinding targets, the rangefinding targets being targets present in a detection range;
generating rangefinding information indicating the distance and direction of each of the rangefinding targets;
capturing an image with at least a portion of an imaging range overlapping the detection range and generating image data indicating the image;
specifying distance, direction, and type of an imaged target and generating imaging information indicating the distance, direction, and type of the imaged target, the imaged target being a target included in the image;
specifying tentative values indicating sizes of the rangefinding targets by using the imaging information;
specifying a plurality of tentative areas in accordance with the tentative values and the rangefinding information, the tentative values being areas in which the rangefinding targets are projected onto the image; and
calculating match probability indicating possibility of the imaged target matching each of the rangefinding targets by using a dimension of an overlap between each of the tentative areas and a target area, the target area being an area in the image capturing the imaged target.
